(19) United States
(12) Patent Application Publication
(10) Pub. No.: US 2007/0198586 A1
(43) Pub. Date: Aug. 23, 2007

(54) Methods and apparatus for providing a configurable geospatial data provisioning framework

(76) Inventors: Mark David Hardy, Castle Rock, CO (US); Philip Webster Barker, Englewood, CO (US); Mark Allan Koch, Broomfield, CO (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/359,680

(22) Filed: Feb. 22, 2006

(51) Int. Cl. G06F 7/00

(52) U.S. Cl. 707/104.1

(57) ABSTRACT

An interactive geospatial data provisioning application presents a graphical user interface operable to present a map of geographic regions and corresponding geospatial data sets. The user selects the area of interest from the mapped regions corresponding to the available geospatial data sets. The application identifies geospatial data sets within the area of interest. By analyzing the attributes available in the identified geospatial data sets, the geospatial data application determines the operations applicable to the data sets. A set of transformation rules computes the operations available for a particular selection of geospatial data sets. A custom plugin generator allows a user to define and insert geospatial operations into the provisioning sequence. The application presents the available predefined and user defined operations, and the user select the geospatial data operations to apply from among the available operations. The geospatial data provisioning application applies the selected operations to the identified geospatial data sets.

### RELATED APPLICATIONS

This application claims the benefit under 35 U.S.C. § 120 of copending patent application Ser. No. 10/990,205, filed Nov. 16, 2004, entitled “SYSTEM AND METHODS FOR PROVISIONING GEOSPATIAL DATA” (Atty. Docket No. SNZ04-01), incorporated herein by reference in entirety.

### BACKGROUND OF THE INVENTION

In a typical business enterprise, the notion of data, or the collective intellectual property of employee knowledge, constitutes one of the key assets of any organization. As a key asset, data must be properly leveraged and managed according to its usage and impact to the organization. Not all data is created equally, and every organization values specific types of data more than others. Many organizations characterize their data based on its importance, which translates to the amount of money and resources spent in acquisition, management, and maintenance. Once an organization has determined the relevance of certain data assets, the organization can develop adequate policies to deliver the corresponding level of support. One type of data asset of particular significance in terms of acquisition and management cost is geospatial data. Geospatial data represents various aspects of a particular geographic area, such as topography, vegetation, moisture, or virtually any detectable quality of a particular area or region. With conventional geospatial data, the issues surrounding management can become particularly complex and expensive acute due to the size of the data and the computationally intensive operations typically associated with the geospatial data.

Conventional corporations, or enterprises, typically require significant capital to acquire and maintain their assets. These business benefits must outweigh these asset costs in order to justify the expense. In essence, all data created or purchased by an organization must promise a return on investment for the duration of that asset's existence. In many organizations, asset costs are confined only to the acquisition costs. Total asset cost can be more accurately determined by identifying all of the cost components over the entire life of the asset. Regardless of how an organization values its geospatial data, optimizing the value associated with the asset will provide a higher return to the organization.

With respect to conventional geospatial data assets, such issues typically include acquisition, processing, and management of the conventional geospatial data to mitigate duplication and redundancy of data logistics, computation, and delivery of the resulting data product to a data consumer organization (internal or external). Geospatial data is often sold or licensed by commercial organizations or public agencies, to offset the substantial costs associated with acquiring and preparing generating geospatial data for general usage. Since purchasing, or acquisition of conventional geospatial data can be costly, it is typically justified based on a specific mission or project. The conventional acquisition process occurs through internal methods or through commercial remote sensing or vector data providers. Costs may be optimized through contracting methods, however in many cases, the purchasing stakeholders do not identify other stakeholders within the organization before purchasing data. Sharing costs among multiple stakeholders leads to reducing the overall data acquisition costs per project and reduce redundancy. In many cases, geospatial assets could be effectively leveraged throughout an organization at all levels of the business but due to traditional management and dissemination challenges, the potential effectiveness of the information cannot be realized.

Geospatial data typically encounters substantial mathematically intensive processing in order to generate a desired and usable data product. The organization stakeholders in who purchase the data often determine how the data will be processed for delivery. These special processing tasks lead to additional, costs as the data is often output into formats specific only to the project specified by one group of stakeholders. Although contracting the processing in most cases is more cost-effective than doing the work in-house, there may be cases where processing the data renders the result unusable by other organizations, thus reducing the ability to share costs and elevate the data to an enterprise use level.

Further, conventional data management for these large volumes of data can be very costly and can be prohibitive for some organizations. Specifically with large imagery archives, building highly available and redundant archive systems add to the complexity and costs of effectively managing these assets. Although the acquisition and processing costs for an asset may only occur once, management costs are recurring and increase over time. The three key cost considerations for data management of geospatial data include storage, protection, and distribution of the geospatial data assets.

The actual geospatial data assets typically codify a variety of geographic features, properties, and other attributes pertaining to a particular region or area, which are enumerated, normalized, and stored as so-called raw geospatial data sets. These raw geospatial assets require a certain amount of specified post processing based on the requirements of each end user application. Geospatial data, therefore, includes various forms of information gathered about particular characteristics of a geographic area, typically gathered by scanning a geographic region partitioned according to a grid overlay. Geospatial image data is often used to generate a map of a geographical area to denote various features of interest. Such geospatial image data is gathered by a variety of techniques, such as via satellites and aircraft, and encompasses data gathered by a variety of sensor mediums, such as optical, radar, infrared, laser, manual survey, and other suitable methods. Often, as indicated above, the geospatial image data is processed through computationally intensive mathematical synthesizing operations to obtain a particular output set. The synthesizing operations typically require significant manual efforts, and require substantial time and computational resources to compute. These operations create derivative datasets which are close to the original but differ due to errors called resampling. As the derivative datasets become more removed from the raw dataset, the errors are amplified and the resulting datasets become further in truth from the original measured information. This is the main reason that many geospatial data users prefer to work directly with the raw imagery rather than derivative datasets.

Conventional raw geospatial data has been and continues to be gathered by a variety of governmental and private entities. The National Geospatial-Intelligence Agency (NGA), The National Reconnaissance Office (NRO), and the Federal Geographic Data Committee (FGDC) are among the various entities that catalog raw as well as processed geospatial data. Processed geospatial data is typically used in Geographic Information Systems (GIS) according to protocols such as the National Spatial Data Infrastructure (NSDI), promulgated by organizations such as the FGDC, and embodied in the National Geospatial Data Clearinghouse, a public domain collection of geospatial data organized to promote cooperative production and sharing of geospatial data among federal, state, academic, corporate, and private entities having an interest in geospatial data. While initially developed to support intelligence operations for military purposes, geospatial data is often employed for a variety of research and consumer purposes, including oil and gas mining, agricultural conditions, real estate development and surveying, outdoor expeditions such as camping, hunting and fishing, and even recreational endeavors such as golf and flight simulation. For each of these specific “vertical” applications, raw geospatial imagery must be processed to create a derivative dataset specific to the needs of those individual applications.

### SUMMARY

Geospatial data typically involves very large data sets which are cumbersome, complex and computationally intensive to process. Traditionally, geospatial output, typically data sets or images produced from raw geospatial data, have been produced through time intensive manual computations by highly skilled operators. These conventional computations typically involve gathering the raw geospatial data from geospatial data sets concerning a geographic area of interest, and synthesizing the raw data with other geospatial data sets to generate the desired output image, or product. Geospatial operations for synthesizing the geospatial data sets involve mathematical convolutions and image processing techniques such as resampling, polynomial warping, filtering, projecting, masking, and other operations as are known to those skilled in imagery science, otherwise known as remote sensing. Further, because the geospatial data assets represent value to the stakeholders (users) who initially finance, manage and process such data, the geospatial data is generally distributed across multiple organizations, in stovepipe imagery archives or data sources, some of which are discussed above.

Accordingly, a typical conventional geospatial data request takes the form of a user query indicative of a particular area and type of output image or map. Such conventional requests typically employs a GIS or remote sensing specialist familiar with the relevant data sets and trained in the applicable image processing operations. Such a request may be, for example, an operation combining three dimensional elevation data with ground permeability to identify likely flood areas due to be used by a real estate developer or insurance company. Another example might illustrate a shift over time (temporal), such as an operation which detects the changes in vegetation over time for a specific area which could be used to illustrate the effect of a polluted river. However, the conventional end user requesting the data does not possess the expertise to create these datasets themselves and therefore relies on the skills of a third party. The end user therefore experiences an often lengthy lag time in fulfilling the data request, conveying the request to the GIS specialist, and waiting for the GIS specialist to process it from the raw imagery. Further, a discrepancy or misunderstanding may result in an erroneous or inaccurate result, compounding the lag time due to repeated and/or refined efforts. Accordingly, users may anticipatorily request geospatial data output on the mere potential to need such output at a future time. Such preemptory requests tend to increase the overall workload, increase response time for all requests, and result in output geospatial data sets which are likely to be “mothballed,” or passively stored, until obsolete or not relevant to the matter for which they were procured.

For an organization to optimize geospatial data asset costs, decision makers must adopt more efficient and consistent processes and enforce them with specific tools and technologies. One of the processes that allow organizations to optimize their costs is geospatial data asset provisioning. The term provisioning is used more traditionally for the acquisition of hard goods such as computers, vehicles and gasoline. Similarly, Geospatial Data Provisioning processes combine the management of assets with efficient distribution and preparedness with the success of the process defined by how effective the asset was utilized by the enterprise. Applied to geospatial assets, provisioning can be defined as the ability to provide custom geospatial data from an accessible archive of raw source imagery in a format specific to each individual end user. Extended further, spatial data provisioning provides custom datasets to a wide variety of end users based on the particular requirements of the specific mission or objective.

Therefore, because of the costs involved with processing and managing geospatial data, the raw data sets and resulting synthesized output sets are viewed as an important asset by the organizations maintaining and providing such geospatial output to the consumers of the data. Accordingly, geospatial data sets are the subject of license, maintenance, and ownership agreements of substantial value. By some accounts, as much as 2% of all Federal spending is directed toward acquisition, storage, and processing of geospatial data. Accordingly, it would be beneficial to provide a system and method for provisioning geospatial data to facilitate delivery of the output geospatial data set as a product to the end user as one method of increasing the utilization of the assets, reducing duplicity and reducing overall asset management costs.

The concept of provisioning data suggests that an organization first have a stock of spatial data prepared before a need arises. Once the need occurs, an efficient provisioning process rapidly extracts and aggregates one or many source data sets into an output data product in the format specific to the end user. To support this process, the source data is typically pre-staged and catalogued for easy search, retrieval, and provisioning—this is referred to as the ingest process. From a data storage perspective, the ability to access these large datasets in real time or near real time requires a method for developing a virtual catalog of imagery regardless of where it physically resides within the organization. A process for aggregating individual datasets from various locations on multiple media formats is a desirable component of an enterprise data-cataloging system according to particular configurations discussed herein.

The spatial data provisioning process consists of several integrated components. A data catalog records the attributes of specific data sources and stores this information in a relational database system indexed based on the geographical location of each asset. The catalog provides search and retrieval capabilities based on spatial, temporal and the various data attributes. The geospatial data is typically stored in its original source format—both in file format and spatial context, and is then provisioned specific to the needs of each end user. In this sense, provisioning includes certain image manipulations, or geospatial operations, to reprocess, reproject, resample, reformat and combine various datasets in rapid fashion. Centralized business logic rules, or transformation rules, apply to the creation of specific derivative data sets to automate repetitive and complex image creation requests. These business rules are linked to specific types of data or combinations of data and are accessed based on the policies of each organization. The application of these business rules to the geospatial assets reduce errors, assure consistency, reduce the required end user skill level and generally allow end users to easily integrate these assets into traditional decision support operations. In this manner, spatial data provisioning as discussed herein represents the next generation of managing and disseminating spatial data.

Therefore, the business rules define permitted interactivity between the users, geospatial data sets (data sets) and geospatial operations (operations). The above described spatial data provisioning process is discussed further in the parent U.S. patent application Ser. No. 10/990,205, filed Nov. 16, 2004, entitled SYSTEM AND METHODS FOR PROVISIONING GEOSPATIAL DATA (Atty. Docket No. SNZ04-01), incorporated herein by reference. The disclosed geospatial data provisioning application provides an interactive mechanism for specifying and transforming geospatial data sets according to a predetermined set of operations. Configurations discussed further below are based, in part, on the observation that users may wish to define the geospatial operations for use in the geospatial data provisioning application. The geospatial operations define geospatial logic, such as transformations, manipulations and other processing, often including complex and computationally intensive arithmetic functions, performed by the operation on one or more applicable geospatial data sets. Such geospatial operations operable for use with the provisioning system correspond to business rules applicable to the operation, such as applicable geospatial data sets and users. The geospatial operations also define parameters required by the operations and security constraints for safeguarding sensitive data.

Accordingly, conventional geospatial data provisioning may limit a user to a predefined set of operations for performing on the available geospatial data sets. Such a predetermined set may not be entirely congruent to each user's needs, or may not generate geospatial output data sets in an optimal form. Therefore, users may wish to inject user defined geospatial operations as custom processing directives into the geospatial data provisioning process. In the geospatial data provisioning framework disclosed herein, such custom processing takes the form of a user defined plugin which a user incorporates into the provisioning framework. Therefore, configurations herein substantially overcome such shortcomings by allowing a user to define a set of instructions as a plugin for geospatial processing, including specifying a sequence of transformations (geospatial operations), define the types of data sets the transformations are applicable to, specifying the business rules concerning the data sets and users that are employable in conjunction with the plugin, and registering the plugin with the geospatial provisioning framework for use by others.

The geospatial data provisioning framework discussed herein allows customization of the provisioning process by providing for a user defined provisioning plugin accessible via the GUI in a similar manner as other geospatial provisioning operations. The standard provisioning process involves a predefined set of operations to be performed on the raw geospatial data sources. To enhance the provisioning process, a user may want to apply either third party or custom processing directives into the standard provisioning process. This can be accomplished by creating a provisioning plugin. The provisioning plugin can be defined as an external processing algorithm and associated conversion algorithms which the framework integrates into the standard provisioning process to create a custom provisioning process.

The disclosed provisioning framework employs custom plugins in the following manner:

(1) Creation of a geospatial data processing algorithm (process): A user defined set of instructions provides the geospatial processing component of the plugin and provides the execution logic for the custom processing that is to be incorporated into the provisioning process. The format for input to this algorithm is variable and the semantics for communicating with the algorithm are specific to the plugin definition (discussed further in (2) below). The execution success or failure and the results of its execution will be reported back to the caller of the plugin, as with other predefined operations available through the geospatial data provisioning application. In addition to a custom geospatial data processing algorithm, the framework may also include the inclusion of a third party commercial algorithm.

(2) Creation of the set of instructions forming the plugin definition:
a. Definition of a job transformation procedure: The standard provisioning process is described by a text document in a self-describing format, or job description, that details the processing parameters used in the provisioning process. The plugin definition may provide a transformer/translator which will be applied to the self-describing document to create the input data required to execute the processing algorithm (execution logic) described above in (1).
b. Definition of calling semantics: The plugin definition specifies how the processing algorithm is presented with the transformed provisioning process description from (2)a and how to initialize and execute the algorithm from (1).
c. Definition of algorithm specific processing parameters: The plugin definition may include processing parameters which are employed by the processing algorithm (1) and are not included in the self-describing document described above (2a).
d. Definition of business rules: The plugin definition may include rules that describe the characteristics of applicability of the algorithm, such as allowed users and to what types of geographic data the algorithm is applicable. These business rules are described in the provisioning framework and are initiated during the spatial data provisioning end user process.
e. Definition of security constraints: The plugin definition may include a list of security constraints to be applied when the plugin is executed.

These security constraints include the ability to define which users or group of users are permitted to execute the provisioning processes specific to each algorithm.

3) Registration of the plugin: The plugin is installed and registered with the provisioning system. The registration process will also specify the where the plugin should be inserted into the standard provisioning process as provided by the geospatial data provisioning application and framework.

In further detail, the method of geospatial data provisioning using the framework herein includes defining a set of instructions for processing at least one geospatial data set, defining one or more business rules indicative of geospatial data sets applicable to the set of instructions, and registering the defined set of instructions and the defined business rules for access via an interactive geospatial data provisioning engine. In the exemplary configuration, the defined set of instructions is a plugin definition, such that the plugin definition includes an indication of a set of applicable operations, a set of applicable data sets, and a set of applicable users. The business rules are indicative of at least one of geospatial data sets upon which the plugin is operable, geospatial operations applicable to the geospatial data sets, and users permitted to employ particular operations. The business rules may be further indicative of a conditional sequence of execution based on the users invoking the plugin and the geospatial data sets requested by the invocation.

Obtaining the set of instructions from the user includes several mediums, including defining the set of instructions in a self describing document, and transforming the self describing document into the plugin definition. The user defines the set of instructions in a plugin definition, in which the plugin definition has instruction segments, such that the instruction segments include specifications of least one of geospatial operations, geospatial data sets, users, parameters and execution logic. In particular arrangements, the plugin definition includes qualifiers for each of the instruction segments, such that the qualifiers are indicative of conditional performance effecting the sequence and security of operations executable by the plugin definition.

Another medium involves defining the plugin definition via a graphical user interface operable to interactively query a user for instruction segments, in which the instruction segments include business rules, such that the business rules define applicable geospatial operations, users and data sets, execution logic indicative of an order for performing the data sets defined in the business rules, plugin parameters operable for interactive specification, and security constraints indicative of restrictions on performance of the execution logic.

Once registered, invoking the plugin includes selecting the registered plugin from a set of registered plugins, and invoking the registered plugin according to predetermined semantics, such that the registered plugin is accessible to users according to the business rules. Invoking the plugin includes providing processing parameters, in which the processing parameters are employed by the geospatial operations for processing the geospatial data sets. The geospatial data provisioning application selects geospatial data sets for inclusion in transformations specified by the operations instruction segment in the plugin, and validating that the selected geospatial data sets are compatible with the transformations. Invoking the registered plugin may further include interactively specifying plugin parameters during execution of the plugin, in which the plugin parameters are independent of the execution logic defining the sequence of operations performed.

In the exemplary configuration, the plugin definition includes execution logic, such that the execution logic is indicative of a sequence of geospatial operations performable on at least one geospatial data set. The execution logic further includes an indication and sequence of at least one geospatial operation to perform, in which each of the geospatial operations includes at least one transformation on at least one of the geospatial data sets.

The invention as disclosed above is described as implemented on a computer having a processor, memory, and interface operable for performing the steps and methods as disclosed herein. Other embodiments of the invention include a computerized device such as a computer system, central processing unit, microprocessor, controller, electronic circuit, application-specific integrated circuit, or other hardware device configured to process all of the method operations disclosed herein as embodiments of the invention. In such embodiments, the computerized device includes an interface (e.g., for receiving data or more segments of code of a program), a memory (e.g., any type of computer readable medium), a processor and an interconnection mechanism connecting the interface, the processor and the memory. In such embodiments, the memory system is encoded with an application having components that, when performed on the processor, produces a process or processes that causes the computerized device to perform any and/or all of the method embodiments, steps and operations explained herein as embodiments of the invention to allow execution of instructions in a computer program such as a Java, HTML, XML, C, or C++ application. In other words, a computer, processor or other electronic device that is programmed to operate embodiments of the invention as explained herein is itself considered an embodiment of the invention.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, with emphasis instead being placed upon illustrating the embodiments, principles and concepts of the invention.

FIG. 1 is a context diagram of geospatial data users, assets, and operations managed, stored, and processed by the configurations discussed herein.

FIG. 2 is a block diagram of an exemplary geospatial data environment suitable for use with configurations of the invention;

FIG. 3 is an exemplary flowchart of geospatial data provisioning in the environment of FIG. 1;

FIG. 4 is a data flow diagram of a geospatial data provisioning application in the geospatial data provisioning server of FIG. 2 and operable for provisioning geospatial data as in FIG. 3;

FIG. 5 is a block diagram of the geospatial data provisioning application of FIGS. 2 and 4 in greater detail;

FIG. 6 is a context diagram of configurable business rules employed for custom plugin definition used to define a user specified operation in the geospatial data provisioning application of FIG. 4.

FIG. 7 is a flowchart of custom plugin specification for geospatial data provisioning in the geospatial data provisioning application of FIG. 4;

FIG. 8 is a block diagram of a configuration including a custom plugin generator in the geospatial data provisioning application for custom plugin generation as in FIG. 5; and

FIGS. 9-12 are a flowchart of custom plugin definition using the custom plugin generator of FIG. 7 in the geospatial data provisioning application of FIG. 4.

### DETAILED DESCRIPTION

Configurations discussed further below provision geospatial data in such a manner that users may search for existing available geospatial data sets concerning an area of interest, define available geospatial operations for the geospatial data sets by selecting in a point-and-click manner, and generate the resulting geospatial output data sets by applying the selected geospatial operations to the data sets. The interactive geospatial data provisioning application provides a graphical user interface operable to present a map of geographic regions and the corresponding geospatial data sets available. The user selects the area of interest by searching, panning and zooming over the mapped regions which outline and identify portions covered by the available geospatial data sets. The geospatial data provisioning application identifies geospatial data sets within the area of interest. By analyzing the attributes available in the identified geospatial data sets, the geospatial data provisioning application determines the geospatial data operations which may be performed on the data sets. A set of transformation rules (business rules) enumerates the attributes and conditions which correspond to particular operations, and therefore computes the operations available for a particular selection of geospatial data sets. The geospatial data application employs a GUI to present the available operations, and the user selects the geospatial data operations to apply from among the available operations. The application further employs an access control list associated with each geospatial data set to ascertain if the requesting user has sufficient access to the data sets included in the request. The geospatial data provisioning application applies the selected operations to the identified geospatial data set or sets to generate the resulting output data set as a finished product. The output data set is rendered by the application on a graphical output display, via the GUI, using an appropriate available file format or graphical display mechanism.

Further, extensions to the available geospatial operations employable by the user are provided in the form of custom geospatial plugins. The custom geospatial provisioning plugin is a set of instructions defined by the user for incorporation with the geospatial data provisioning application. A custom plugin generator provides an interface allowing a user to define a set of instructions as a plugin for geospatial processing, including specifying a sequence of transformations (geospatial operations), defining the types of data sets the transformations are applicable to, specifying the business rules concerning the data sets and users that are employable in conjunction with the plugin, and registering the plugin with the geospatial provisioning framework for use by others.

The geospatial data provisioning framework discussed herein allows customization of the provisioning process by providing for a user defined provisioning plugin accessible via the GUI in a similar manner as the other predefined geospatial operations available via the geospatial data provisioning application. The standard provisioning process involves a predefined set of operations to be performed on the raw geospatial data sources. To enhance the provisioning process, a user injects custom processing directives into the standard provisioning sequence by creating a custom geospatial provisioning plugin (custom plugin). The custom plugin may defined as an external processing algorithm and associated conversion algorithms which the framework integrates into the standard provisioning process to create a custom provisioning process.

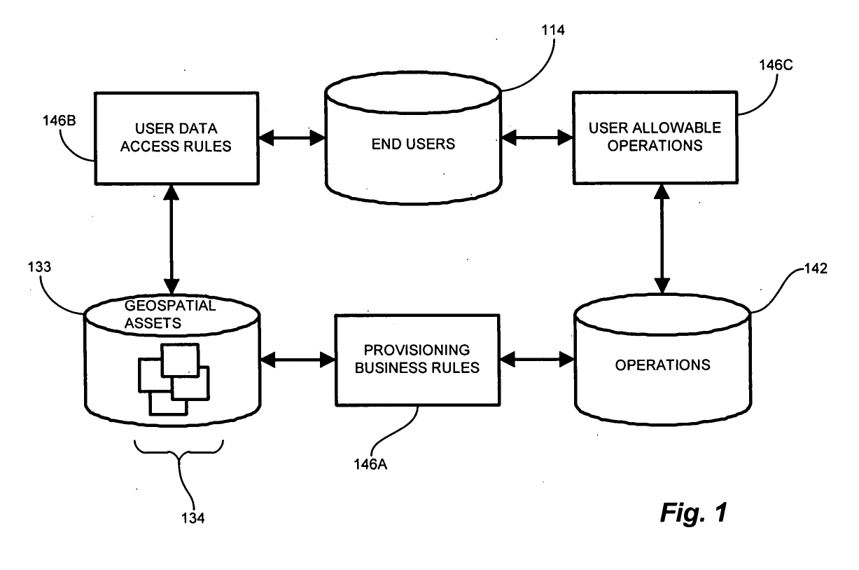

FIG. 1 is a context diagram of geospatial data users, assets, and operations managed, stored, and processed by the configurations discussed herein. Referring to FIG. 1, geospatial data assets typically include geospatial data sets 134, as collections of raw information concerning geospatial attributes of a particular area as is known to those of skill in the art. Accordingly, FIG. 1 describes the high level entity relationships between the three primary components discussed herein: end users 114, geospatial assets 133 and operations 142, and describes the intersecting business rule logic therein. The concept of the exemplary configuration discussed herein relies on these three virtual objects 114, 133 and 142 and their relationships within an overall process. These objects include a user or person who will create the desired data, geospatial assets which include the acquired data, and operations including the algorithms which can be used to produce data products. End users, or simply users 114 employ and manage the geospatial data sets 134 according to the user access data rules 146B, employing the operations 142 as permitted by the user allowable operations rules 146C, which apply the operations 142 to the geospatial data sets 134 according to the provisioning business rules 146A. The methods implemented by the rules 146A, 146B and 146C collectively form a set of transformation (business) rules 146, discussed in further detail below.

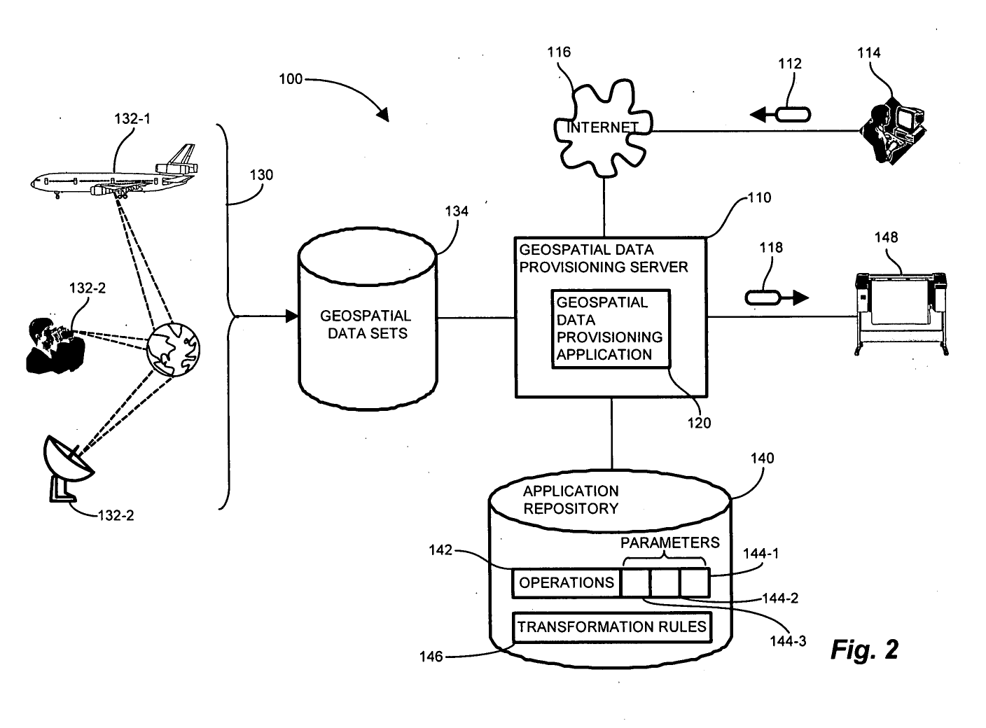

FIG. 2 is a block diagram of an exemplary geospatial data environment 100 suitable for use with configurations of the invention. Referring to FIG. 2, the environment 100 includes a geospatial data provisioning server 110 including a geospatial data provisioning application 120. The data provisioning server 110 is in communication with a plurality of geospatial data sets 134, stored by a variety of suitable means discussed further below. A geospatial data infrastructure 130 is operable to capture and store geospatial data from any suitable source, including aerial sensory reconnaissance 132-1, ground surveying and tracking 132-2, satellite imagery techniques 132-3, and other mechanisms for storage as the geospatial data sets 134. The geospatial data sets 134, therefore, are raw, sensory based geospatial data gathered from the infrastructure 130 for processing by the geospatial data provisioning application 120 (application). Alternatively, there are cases whereas the geospatial datasets 134, may be processed into a more usable format by automated techniques employed by third parties. These processes geospatial datasets also reside in 134.

An application repository 140 includes predetermined operations 142 operable for processing and transforming the geospatial data sets 134 according to transformation rules 146 indicative of the types of geospatial data sets 134 and applicable operations 142, also discussed further below. Each of the operations 142 may have one or more parameters 144-1 . . . 144-N corresponding to attribute data in the geospatial data sets 134 and the associated transformation rules and adapted for population therefrom. The geospatial data provisioning application 120 is operable to employ the operations 142 in response to a data provisioning request 112 from a user 114, received via a public access network such as the Internet 116, to generate a responsive geospatial output data set 118, or image, to an output medium such as a data storage device, graphical display device 148 (i.e. printer, graphic screen, plotter, etc.). Typically, such a geospatial output data set 118 is an output image displayable in a graphical form such as a map, however is operable to be an alternate form of synthesized results from transformations applied to raw or pre-processed geospatial data sets 134.

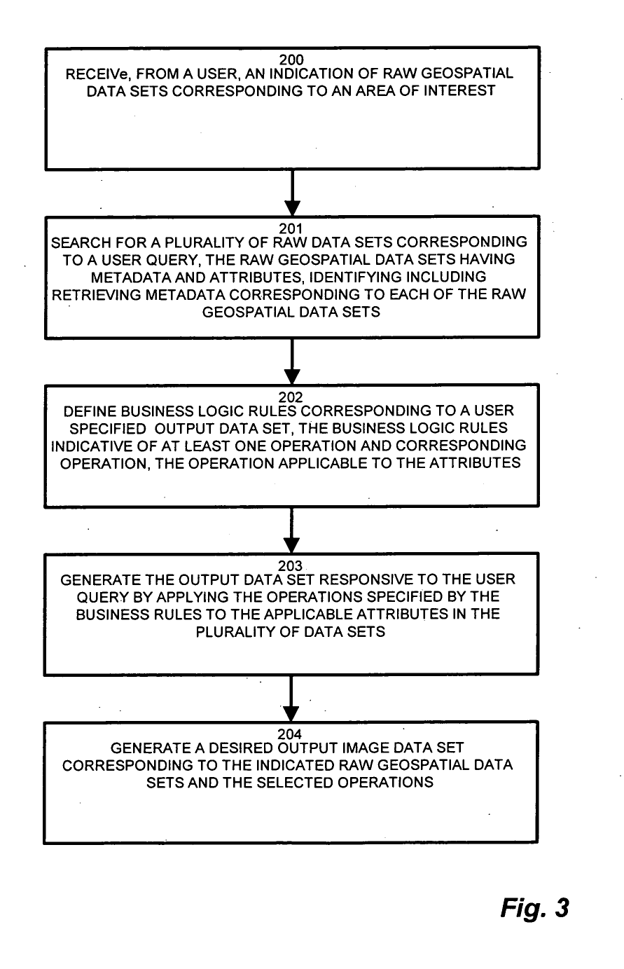

FIG. 3 is an exemplary flowchart of geospatial data provisioning in the environment of FIG. 2. Referring to FIGS. 2 and 3, the method of provisioning geospatial data includes receiving, from a user, an indication of source (lets use the term source to include either raw or pre-processed) geospatial data sets corresponding to an area of interest, as depicted in step 200. As indicated above, the user employs the GUI for selecting an area of interest from a geographical display, or map, typically in the form of a user query 112. Alternatively, the query may be initiated by a third party application which generates a query and communicates with the geospatial data provisioning server in a programmatic method. The area of interest includes one or more previously collected geospatial data sets 134. Accordingly, the data provisioning application 120 searches for a plurality of source geospatial data sets 134 corresponding to the user query 112, as shown at step 201.

In the exemplary configuration discussed further below, the searching occurs after a discovery, or ingestion, phase in which the application 120 catalogs available geospatial data sets prior to and in anticipation of the user query 112. The cataloged data, discussed further below, provides support for provisioning the geospatial data to produce the user specific output data set 118, or image, in advance of actual retrieval of the entire group of geospatial data sets 134 employed by the query 112. The geospatial data sets 134 include various forms and types of geospatial data gathered and stored within the geospatial infrastructure 130. Typically, the source geospatial data sets 134 have metadata and attributes, in which identifying includes retrieving metadata corresponding to each of the source geospatial data sets 134 implicated by the user query 112. Note that the raw data refers to the sensory based input from the various contributing sensors and gathering mechanisms 132-1 . . . 132-3. The geospatial data undergoes several levels of processing to generate the output data set 118, or product. The raw, or level 0 data is orthorectified into level 1 data. Orthorectification refers to orientation of the data to a corresponding earth based reference to which it refers, such as the latitude and longitudinal bounds of the area represented. Multiple orthorectified data sets (level 1) may be transformed one or more times to generate the output data set 118, or level 2 data.

The application 120 is responsive to the transformation rules 146, or business logic rules, which identify applicable operations 142 for applying to user-selected geospatial data sets 134. Accordingly, the application 120 identifies or defines the transformation rules 146 corresponding to a user specified output data set 118 from the query 112. The transformation rules 146 are indicative of at least one operation 142 and corresponding parameters 144, in which the operation or operations 142 are applicable to the attributes of the particular geospatial data sets 134, as depicted at step 202. The geospatial data provisioning application 120 then generates the output data set 118 responsive to the user query 112 by applying the operations 142 specified by the transformation rules (e.g. business logic rules) 146 to the applicable attributes in the plurality of data sets 134, as disclosed at step 203. Using the transformed data sets, the application 120 generates the desired output data set 118 corresponding to the indicated source geospatial data sets 134 and the selected operations 142, typically a graphical output file such as a jpeg, .tif, or other output format as is known in the art, as depicted at step 204, suitable for use within an end users application for display on a graphical output device such as a screen or plotter 148.

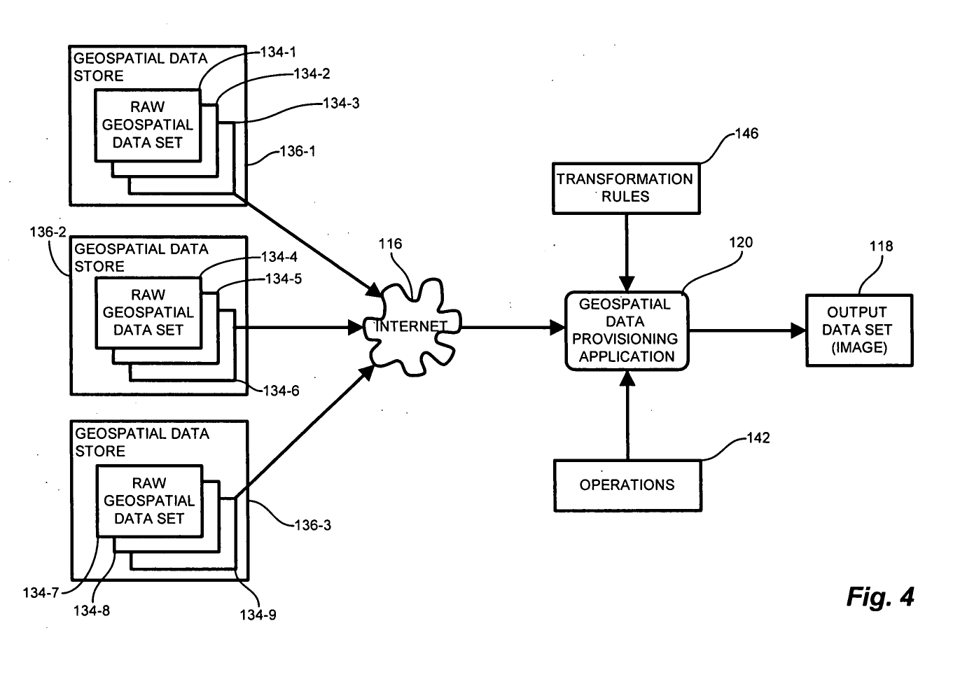

FIG. 4 is a data flow diagram of the geospatial data provisioning application 120 in the geospatial data provisioning server 110 of FIG. 1 and operable for provisioning geospatial data as in FIG. 2. Referring to FIGS. 1 and 3, the geospatial data infrastructure 130 assembles and organizes geospatial data in large databases operating as geospatial data stores 136-1 . . . 136-3 (136 generally), or data sources. As indicated above, such geospatial data stores 136 are generally aligned with geographic and qualitative criteria. Due to the quantity and size of the geospatial data sets 134, network logistics associated with transporting the geospatial data sets are a substantial aspect of geospatial data provisioning. Each geospatial data store 136 stores a plurality of geospatial data sets 134-1 . . . 134-N operable for selective retrieval by the geospatial data provisioning application 120 via the Internet 116. The geospatial data provisioning application 120 employs the transformation rules 146 to determine the operations 142 applicable to (i.e. operable on) a particular subset of raw geospatial data sets 134-N retrieved from the stores 136. As will be described in further detail below, the geospatial data sets 134 include attributes, or fields, concerning the geographic area to which the geospatial data pertains. The geospatial data sets 134 store attribute values employed by the operations. The applicable operations 142 are therefore the operations for which a particular data set or combinations of data sets 134 that can be used to create a custom derivative data set.

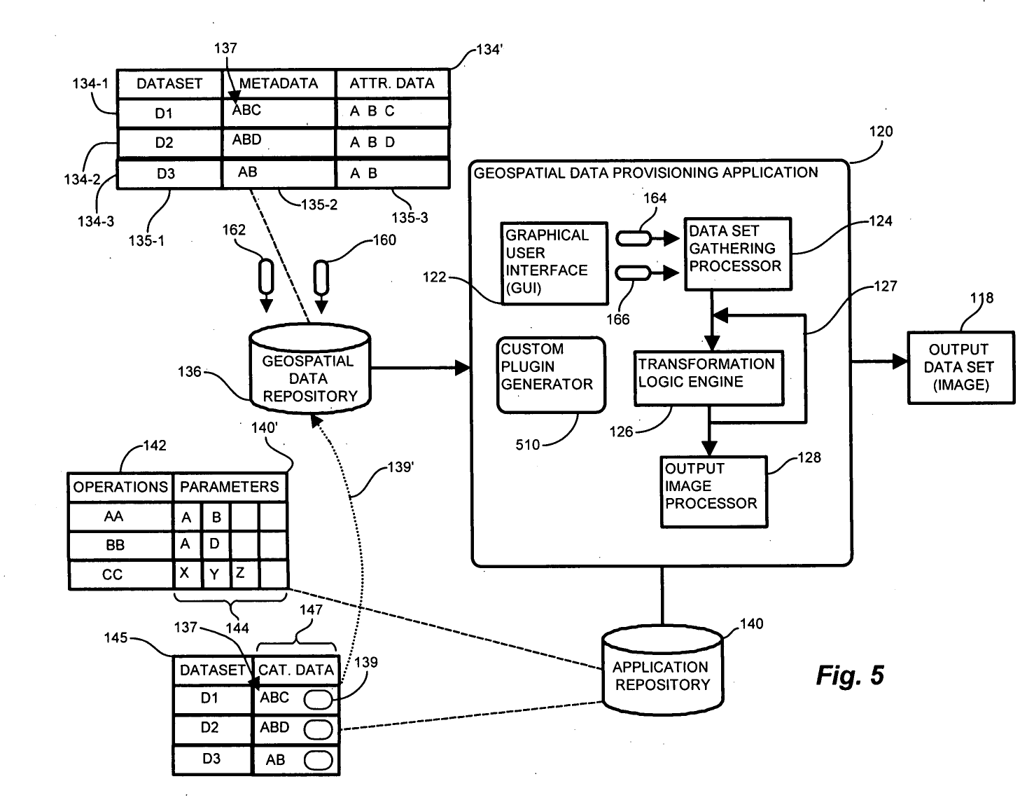

FIG. 5 is a block diagram of the geospatial data provisioning application 120 of FIGS. 2 and 4 in greater detail. Referring to FIGS. 2, 4 and 5, the geospatial data provisioning application 120 includes a graphical user interface (GUI) 122 or programmable interface (i.e. software API or toolkit), operable to receive and display information on behalf of the user 114, a data set gathering processor 124, a transformation logic engine 126, and an output image processor 128. The source geospatial data stores 136-N, abbreviated simply as representative geospatial data repository 136, includes the collective geospatial data sets 134-N. The raw datasets 134 are shown in an exemplary manner in table 134′, which includes, for each dataset 134, a dataset ID, or name 135-1, metadata 135-2, and attribute values 135-3. The application repository 140 is also illustrated as an exemplary table 140′, and enumerates operations 142 and parameters 144.

Illustrating the principles of applicable operations 142, the geospatial dataset table 134′ includes exemplary datasets D1, D2 and D3. Each dataset 134 has metadata 135-2, which typically includes the attributes names 137 and locations of the source data and the thumbnail data 139 (not necessarily stored in the database, but in the geospatial data repository 136), and may include other information. The data corresponding to the attributes 135-2 is stored as attribute values 135-3. The relationship between the operations and data are such that the user will define a business rule for a combination of data source types (i.e. map and image). Exemplary operations AA, BB and CC are shown in table 140′, along with expected parameters 144. Therefore, operation AA is applicable to datasets D1, D2 and D3 because each has the expected parameters A and B. Operation BB is applicable only to dataset D2, having expected parameters A and D, and operation CC is not applicable to any of D1, D2 or D3, lacking the requisite parameters X, Y and Z. Note that this example is illustrative, and more complex relations may typically exist between datasets 134 and operations 142, and are expressible in the transformation rules 146. For example, certain geospatial operations 142 may be binary, expecting two or more data sets, or unary, and operable on only a single data set. Typical geospatial operations include transformations, projections, resampling, combinations, fusing and may include others, as are known to those of skill in the art.

The geospatial data provisioning application 120 also employs a catalog corresponding to provisioned geospatial data. The catalog is shown as table 145, storing catalog data 147 and reference to thumbnail images 139, which may be stored in the geospatial data repository 136 and referenced from the catalog data 147, as shown by dotted arrow 139′, and attribute names 137. The data set gathering processor 124 generates the catalog data 147 as new geospatial data sets 134 are discovered, and stores the catalog data 147 in the application repository 140. Alternatively, the catalog data may be included in the geospatial data repository 136 as an ingested, or discovered data set 134. The cataloged data 145 provides data operable for computing applicable operations and for displaying the low resolution thumbnail without requiring transport of the full geospatial data set 134 such as the attribute data 135-4, until a user selection 112 requests the full data set 134. In the exemplary arrangement, the cataloged data includes the available attributes 137 (i.e. names), references to the thumbnail data 139, the geographic location of the data asset i.e. the geographic region which the data set 134 defines, and a pointer to the actual raw data set. In alternate configurations, the geospatial data provisioning application 120 includes a custom plugin generator 510 for generating and registering custom plugins for geospatial processing, discussed further below.

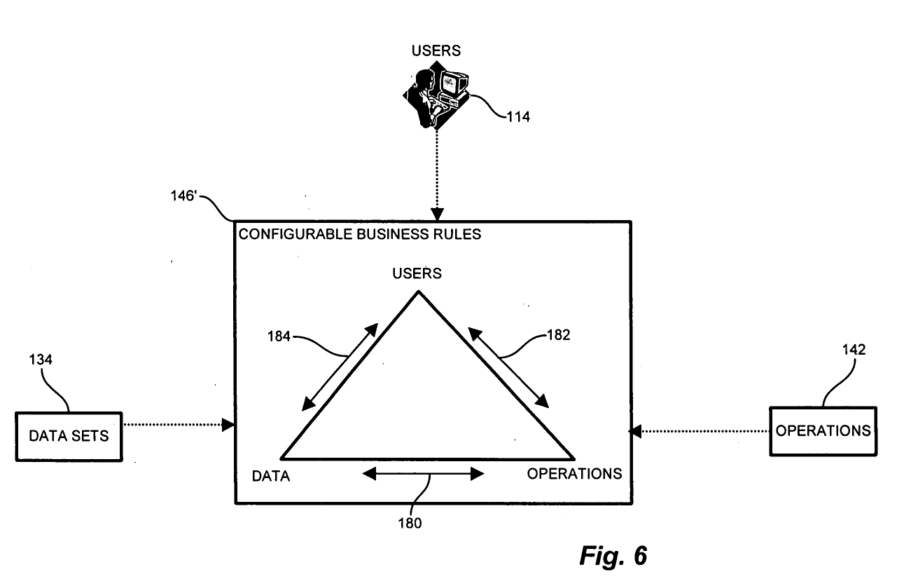

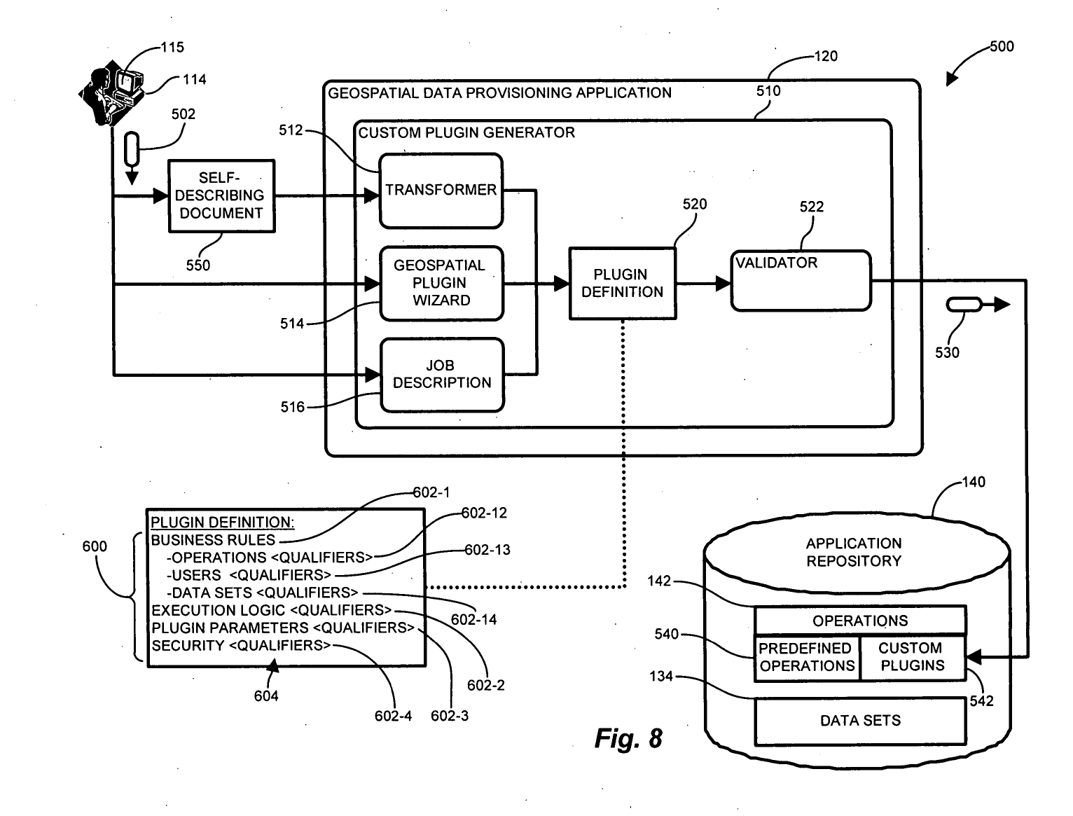

FIG. 6 is a context diagram of configurable business rules employed for custom plugin definition used to define a user specified operation in the geospatial data provisioning application of FIG. 4. FIG. 5 depicts the role of the business rules in a block diagram of the interrelation between the operations 142, data sets 134 and users 114 is depicted. Experienced users 114 or users desiring a particular geospatial processing sequence may find it beneficial to have the ability to define specific geospatial processing sequences for performing a custom set of geospatial transformations or processing resulting in an output data set 118 suited for a particular user defined purpose. The configurable business rules 146′ indicate the data (geospatial data sets) 134 applicable to particular operations 142 (e.g. processing sequences), shown by arrow 180, the users that may employ the operation, shown by arrow 182, and the data sets 134 accessible by particular users 114, shown by arrow 184. A user defined geospatial processing sequence (expressed below in FIG. 8 as a set of instructions 502) therefore allows user configurable business (transformation) rules 146 to define the interrelationships 180, 182, 184 in a normalized form adapted to database driven access. For example, as discussed above, particular operations 142 are applicable to certain data sets 134. Further, certain users may not be given access to particular operations due to the processing resources the operations 142 consume. Similarly, certain users 114 may not have access to certain data sets 134, because of the sensitive nature of the data therein. Other scenarios may be envisioned, however the interrelation between the users 114, data 134 and operations 142 depicted in the configurable business rules 146′ yields a potentially complex array of constraints

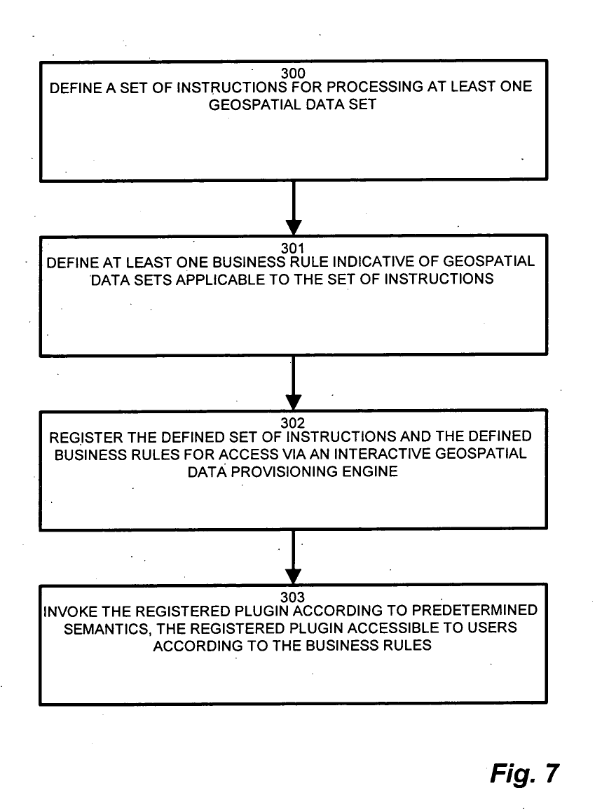

FIG. 7 is a flowchart of custom plugin specification for geospatial data provisioning in the geospatial data provisioning application of FIG. 4, and according to the interrelations between the configurable business rules 146′ depicted in FIG. 6. Referring to FIGS. 5-7, at step 300, the method of providing a geospatial data framework as defined herein includes defining a set of instructions for processing at least one geospatial data set, and defining at least one business rule indicative of geospatial data sets applicable to the set of instructions, as depicted at step 301. The set of instructions is typically created using a self describing document or a GUI wizard, discussed further below. The business rules 146′ defined thereby specify the allowed interrelations, typically which data sets 134 are applicable to particular operations 142, and which users are permitted to employ particular operations and access particular data sets. The business rules permit certain geospatial operations on particular data sets, as determined by compatibility of data types and permissibility of the resultant output data set 118. For example, high resolution images of certain areas may be disallowed due to political or governmental restrictions. Similarly, certain operations commanding a large share of processing resources (i.e. a transformation that consumes several days of processing time) may be reserved for only experienced users.

The geospatial data provisioning application 120 registers the defined set of instructions and the defined business rules for access via an interactive geospatial data provisioning engine (i.e. transformation logic engine) 126, as shown at step 302. Registration validates the operability of the set of instructions and makes it generally available as a registered plugin for other users of the geospatial data provisioning application 120, subject, of course, to the business rules 146′. Appropriate users 114 then invoke the registered plugin according to predetermined semantics, such that the registered plugins are accessible to users according to the business rules, as depicted at step 303.

FIG. 8 shows a further configuration in a custom plugin environment 500. The custom plugin environment 500 includes a custom plugin generator 510 within the geospatial data provisioning application 120. FIG. 8 is a block diagram of a configuration including the custom plugin generator 510 in the geospatial data provisioning application 120 for custom plugin generation as in FIG. 5. Accordingly, referring to FIG. 8, in alternate configurations, the geospatial data provisioning application 120 includes the custom plugin generator 510 for allowing a user to enhance the standard provisioning process of predefined operations 540. The operations 142 in the repository may be augmented by experienced users as a plugin definition 520, which is then registered as an operation (custom plugin 542) in the application repository 140, accessible as any other operation in the repository 140. The custom plugin generator generates registered operations 530 for inclusion as custom plugins 542 accessible as operations 142 in the application repository 140 along with the predefined operations 540 already accessible in the repository 140. Registration inserts the custom plugin 542 in the provisioning sequence where it is accessible by other users. Therefore, the custom plugin generator 510 allows a user 114 to augment the generally accessible operations 142 with custom plugins 542 suited to a particular need and also generally accessible for generating output data sets 118 via the geospatial data provisioning application 120.

A user 114, typically a skilled geospatial engineer or operator, develops the set of instructions 502 and generates a self describing document 550 in a scripted or compiled language that identifies the steps to be performed by the plugin. Alternatively, a geospatial plugin wizard 514 or direct job description 516 may be employed, both discussed further below. The self describing document 550 is a text-based code specification of plugin instructions described in a variety of formats including comma delimited format or as an HTML, GML or XML document, for example. Alternatively, an XML job description 516 may be developed, avoiding the need for a code transformation or compilation by the transformer 512, discussed further below. Other formats may be employed in alternate configurations. Steps include identifying the applicable data sets, transformation logic to be performed on the data sets, and business rules determining which data sets, users, and operations are applicable to the plugin, also discussed further below. The transformer 512 receives the self-describing document 550 and interprets the self describing document to produce a plugin definition 520. The plugin definition 520 includes a set of instruction segments 600 describing the processing performable by the plugin definition 520 in a common language, such as XML.

The plugin definition 520 has a series 600 of instruction segments defining the processing steps performable (executable) by the plugin. The plugin definition, in the exemplary configuration, is a markup language definition, such as XML, either transformed from the self describing document 550 by the transformer, generated by the wizard 514, or directly entered as a job description 512. The latter is likely performed by an experienced operator or geospatial engineer. A validator 522 receives the plugin definition 520 and registers the plugin. Registering the plugin includes verifying validity of the business rules 602-1 defined therein, identifying where the plugin is situated in the provisioning process, and storing the plugin 530 as a custom plugin 542 in the application repository 140. Subsequent users 114 may thereafter access the registered plugin 530 in a manner similar to the predefined operations 540 from the repository 140, subject to the business rules 602-1 defined therein. In summary, the set of instructions 502 defined by the instructions segments 600 identifies a set of geospatial operations 142 for performing on the data sets 134. Each of the operations 142 includes one or more transformations of the geospatial data sets, in which the transformations process the data sets from one form to another, and may include mathematical functions and other image processing processes. Further, the transformations may be unary, binary, or encompass a plurality of data sets, depending on the transformation and the data sets called for by the execution logic 602-2.

In alternate configurations, the geospatial plugin wizard 514 guides a novice user through development of the plugin definition 520. For example, the wizard 514 may present a GUI screen or screen sequence for each of the instruction segments 602. Alternatively, experienced users may enter the job description 512 directly as an XML file, or other native language depending on the data provisioning application 120.

The plugin definition 520 defines a set 600 of instruction segments 602. Each of the instruction segments 602-1 . . . 602-14 (602 generally) specifies a particular portion of geospatial processing steps. Each of the instruction segments 602 includes corresponding qualifiers 604 that specify conditions or branching instructions to the processing performed by that instruction segment 602. A business rules instruction segment 602-1 includes an operations segment 602-12, a users segment 600-13 and a data sets segment 602-14. Each of the business rules segments 602-12, 602-13, 602-14 specifies the interrelations between the operations 142, users 114 and data sets 134, i.e. the conditions under which processing may occur. The execution logic segment 602-2 specifies the geospatial transformations, such as mathematical and computational algorithms and processing manipulative of the geospatial data sets 134. A plugin parameters segment 602-3 gathers any parameters employed for processing which do not affect the rule-based control flow of the plugin, typically by interactive user prompts (business rules 602-1 may be evaluated prior to the plugin parameters instruction segment). Note that geospatial parameters 144 employed which may be interpreted by the business rules, such as data sets 134, are specified during plugin invocation as processing parameters (discussed below), since they may conditionally effect the runtime result of the plugin. A security segment 602-4 specifies security checks for data integrity.

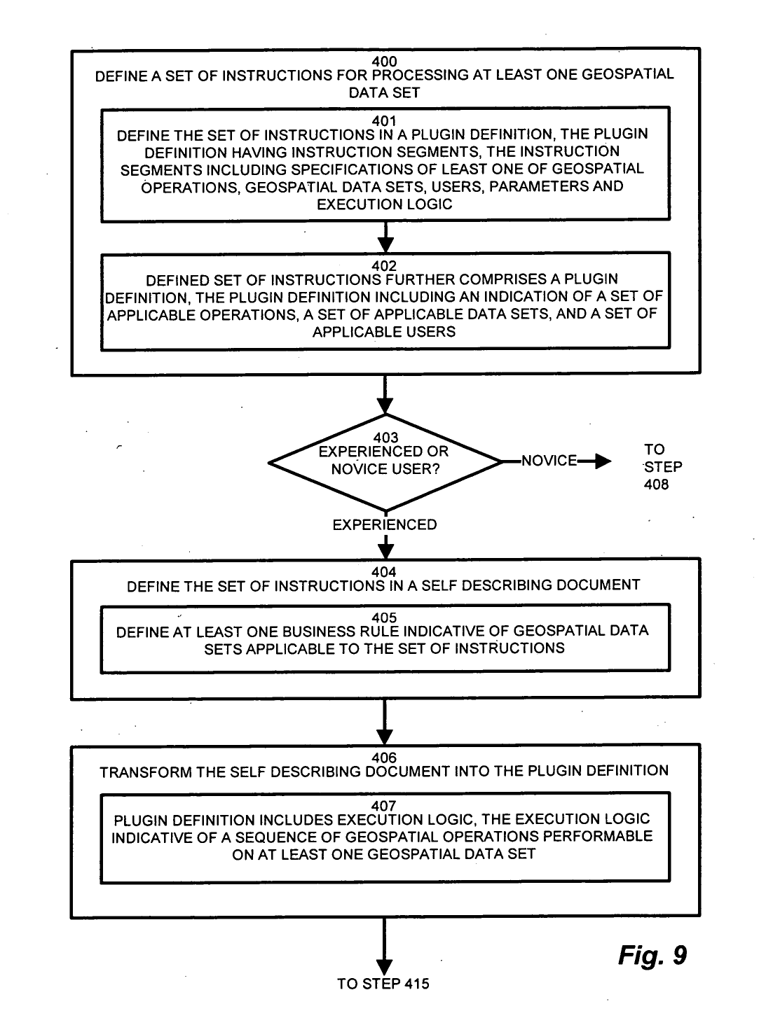

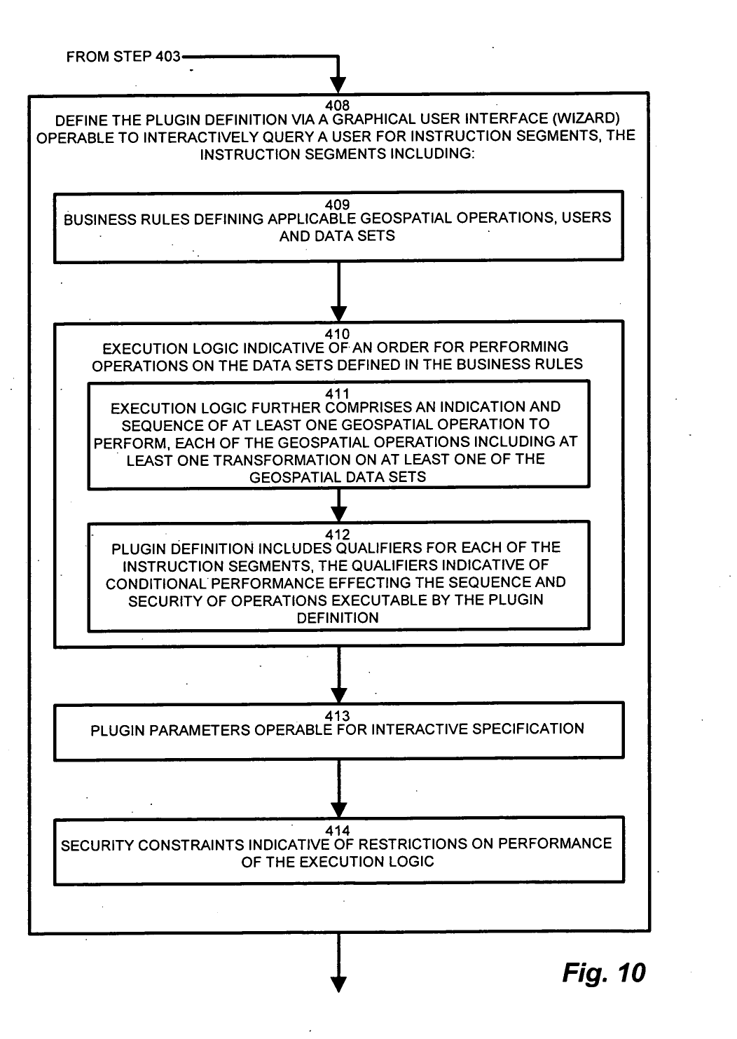

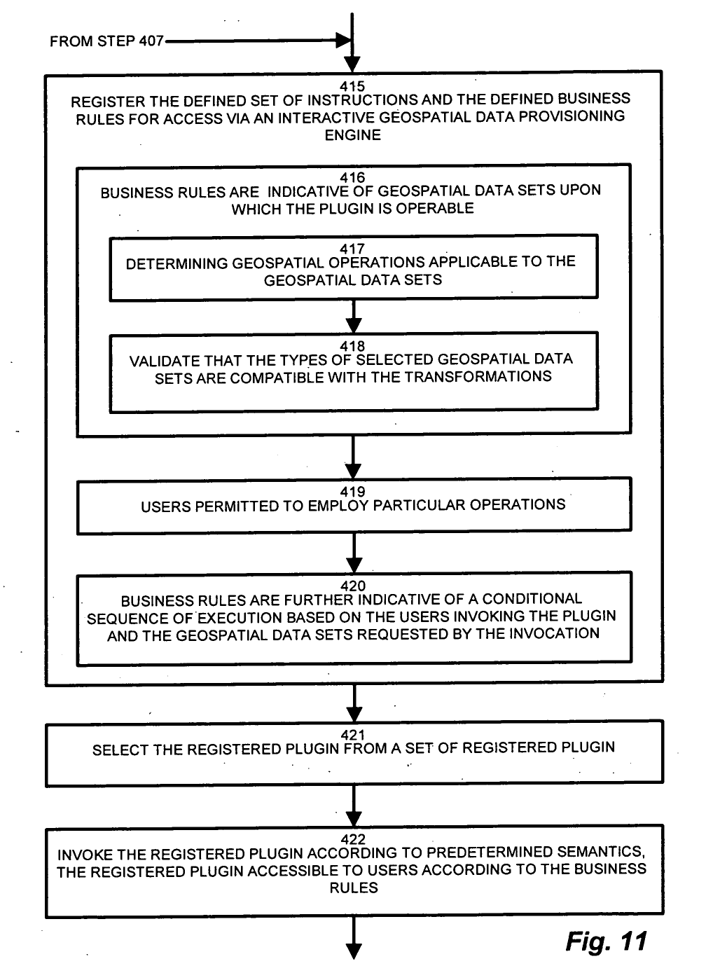

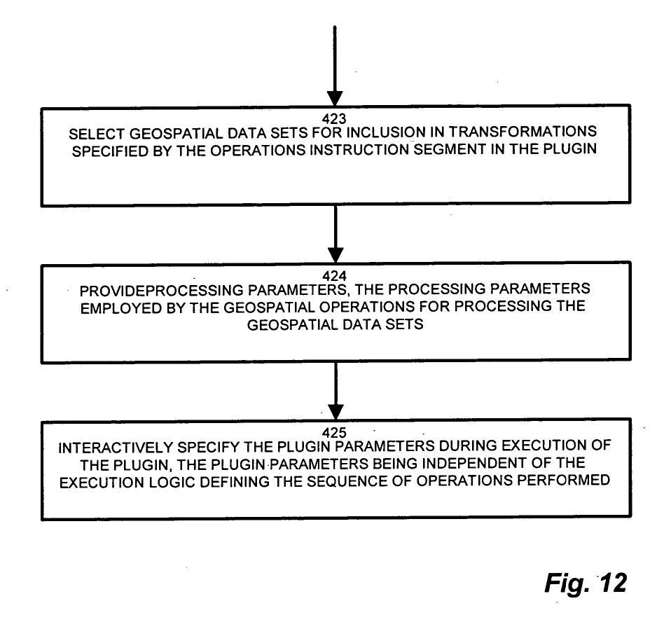

FIGS. 9-12 are a flowchart of custom plugin definition using the custom plugin generator 510 of FIG. 8 in the geospatial data provisioning application 120 of FIG. 5. Referring to FIGS. 8-12, the geospatial data provisioning framework 500 allows the user 114 to define a set of instructions 502 for processing one or more geospatial data sets 134, as depicted at step 400. The framework allows the user to define the set of instructions 502 in a plugin definition 520, in which the plugin definition 520 has a series 600 of instruction segments 602, each including specifications of least one of geospatial operations 602-12, geospatial data sets 602-14, users 602-13, parameters and execution logic 602-2, as disclosed at step 401. Therefore, the defined set of instructions 502 further comprises a plugin definition 520, such that the plugin definition 520 includes an indication of a set of applicable operations, a set of applicable data sets, and a set of applicable users, as depicted at step 402.

The custom plugin generator 510 performs a check, as depicted at step 403, to determine if the user is novice or experienced to select the manner of entering the set of instructions 502. Accordingly, in the case of the experienced user, the user 114 defines the set of instructions in a self describing document 550, as depicted at step 404, such as a text based markup language file, enumerated above.

The set of instructions 502 in the self describing document 550 defines at least one business rule indicative of geospatial data sets 134 applicable to the set of instructions 502, as depicted at step 405. Typically, the user 114 defines a set of business rules (i.e. transformation rules 146) for specifying the applicable data sets 134 and users 114 with the operations 142 specified by the set of instructions 502. The transformer 512 transforms the self describing document 550 into the plugin definition 520, as shown at step 406. Transforming may include translating the self describing document 550 from the user-developed format into a native format, such as XML, expected by the custom plugin generator 510 as the plugin definition 520. Various compilation and interpretation functions may also be employed to produce the plugin definition 520. Alternatively, a user 114 may enter a job description 516 directly in the native format, such as XML, if the user (typically experienced) is conversant with the native format expected by the custom plugin generator 510.

The transformer 512 generates the plugin definition including the instructions from the set of instructions 502 called for by the user. At a minimum, the plugin definition includes execution logic 602-2, in which the execution logic is indicative of a sequence of geospatial operations 142 performable on at least one geospatial data set, as depicted at step 407. Other and additional instructions are included in other instruction segments 602.

In the case of a novice user at step 403, the custom plugin generator 510 provides a geospatial plugin wizard 514 for defining the plugin definition via a graphical user interface 115 operable to interactively query the user 114 for instruction segments 602, as disclosed at step 408. The user 114 enters the sets of instructions 502 as instruction segments 602 including business rules 602-1, in which the business rules define applicable geospatial operations 602-12, users 602-13 and data sets 602-14, as depicted at step 409. At step 410, a user enters execution logic 602-2 indicative of an order for performing the operations 142 on the data sets 134 defined in the business rules 146. The execution logic 602-2 includes an indication and sequence of one or more geospatial operations 142 to perform, such that each of the geospatial operations including at least one transformation on at least one of the geospatial data sets, as shown at step 411. The plugin definition 520 also includes qualifiers 604 for each of the instruction segments 602, in which the qualifiers are indicative of conditional performance effecting the sequence and security of operations executable by the plugin definition 520, as depicted at step 412. Generally, the execution logic 602-2 defines the computationally intensive geospatial processing performed on the data sets 134 to generate or render the output data set or image 118, subject to the constraints in the business rules 602-1.

The geospatial plugin wizard 514 also defines plugin parameters 602-3 operable for interactive specification, as shown at step 413. Plugin parameters are interactively queried from the user during execution of the execution logic, such as output clarification and other information not employed by the business rules 602-1. Parameters employed by the business rules, such as data sets 134, are specified as processing parameters during invocation of the plugin since the business rules employs such parameters to determine the appropriateness of permitting the operations in the plugin.

A security instruction segment 602-4 allows entry of security constraints indicative of restrictions on performance of the execution logic 602-2, as shown at step 414. Such security constraints may include encryption, authentication, and dissemination limitations, for example. Note that user limitations on applicable data sets accessible by a particular user are specified in the business rules 602-1.

Following development of the plugin definition 520 via one of the above methods, the custom plugin generator 510 registers the defined set of instructions (i.e. the plugin) 530 and the defined business rules 602-1 for access via the interactive geospatial transformation logic (data provisioning) engine 126 (FIG. 5), as disclosed at step 415. As indicated above, the business rules 602-1 in the plugin definition 520 are indicative of the geospatial data sets 134 upon which the plugin is operable, as depicted at step 416. Registration therefore includes determining that the geospatial operations 142 called for by the plugin 520 are applicable to the geospatial data sets 134 according to the rules, as shown at step 417. The validator 522 then validates that the selected geospatial data sets 134 are compatible with the transformations specified in the execution logic 602-2. Validation ensures that the types of data in the geospatial data sets 602-14 are operable by the operations 602-12 performed by the plugin, as shown at step 418. Registration further verifies that the users 602-13 are permitted to employ particular operations, as shown at step 419. The business rules 602-1 and associated execution logic 602-2 are therefore indicative of a conditional sequence of execution based on the users invoking the plugin and the geospatial data sets requested by the invocation, as depicted at step 420.

Upon registration as a custom plugin 542 in the application repository 140, the plugin is generally accessible to other users 114 of the geospatial data provisioning application 120. A user 114 selects the registered plugin 530 from a set of registered plugin 542 via the GUI 115, as depicted at step 421. The user 114 invokes the registered plugin according to predetermined semantics, in which the registered plugin is accessible to users according to the business rules 602-1, similarly to the predefined operations 540, as shown at step 422. The plugin begins execution by selecting (locating and retrieving) geospatial data sets 134 for inclusion in transformations specified by the operations instruction segment in the plugin, as depicted at step 423. Invoking may further include providing processing parameters at invocation, in which the processing parameters are employed by the geospatial operations 142 for processing the geospatial data sets 134, as shown at step 424. The processing parameters may be specified in a command line or via a menu pulldown, and are employed to indicate geospatial data sets 134 or other processing parameters. The processing parameters, being specified upon execution, are utilized by the business rules 602-1 in determining applicability of the operation 142. For example, geospatial data sets 134 specified as processing parameters are scrutinized by the business rules 602-1 to ensure that the user 114 is allowed to perform such processing on the geospatial data sets.

Upon invocation, the user 114 may interactively specify the plugin parameters during execution of the plugin, in which the plugin parameters are independent of the execution logic defining the sequence of operations performed, as disclosed at step 425. Therefore, the plugin parameters generally do not affect the logic and computations of the business rules (in contrast to the processing parameters specified at invocation), but rather effect aesthetic and administrative aspects such as output format, tuning parameters, or other information employed by the plugin but not fully defined in the plugin definition 520. In this manner, the geospatial data provisioning application provides a framework for plugin definition to allow user defined custom plugins for specific geospatial processing needs.

The geospatial data provisioning framework and mechanism disclosed herein may encompass a variety of alternate deployment environments. In a particular configuration, as indicated above, the exemplary geospatial data provisioning application discussed may be the EarthWhere™ application, marketed commercially by SANZ Inc. of Englewood, Colo., assignee of the present application.

Those skilled in the art should readily appreciate that the programs and methods for geospatial data provisioning as defined herein are deliverable to a processing device in many forms, including but not limited to a) information permanently stored on non-writeable storage media such as ROM devices, b) information alterably stored on writeable storage media such as floppy disks, magnetic tapes, CDs, RAM devices, and other magnetic and optical media, or c) information conveyed to a computer through communication media, for example using baseband signaling or broadband signaling techniques, as in an electronic network such as the Internet or telephone modem lines. The operations and methods may be implemented in a software executable object or as a set of instructions embedded in a carrier wave. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and method for geospatial data provisioning has been particularly shown and described with references to embodiments thereof, it will be understood by those skilled in the art that various changes in form and details may be made therein without departing from the scope of the invention encompassed by the appended claims.

What is claimed is:

1. A method of provisioning geospatial data comprising:
defining a set of instructions for processing at least one geospatial data set;
defining at least one business rule indicative of geospatial data sets applicable to the set of instructions; and
registering the defined set of instructions and the defined business rules for access via an interactive geospatial data provisioning engine.

2. The method of claim 1 wherein the defined set of instructions further comprises a plugin definition, the plugin definition including an indication of a set of applicable operations, a set of applicable data sets, and a set of applicable users.

3. The method of claim 2 wherein the business rules are indicative of at least one of:
geospatial data sets upon which the plugin definition is operable;
geospatial operations applicable to the geospatial data sets; and
users permitted to employ particular geospatial operations.

4. The method of claim 3 further comprising:
defining the set of instructions in a self describing document; and
transforming the self describing document into the plugin definition.

5. The method of claim 4 further comprising:
selecting the registered plugin from a set of registered plugins; and
invoking the registered plugin according to predetermined semantics, the registered plugin accessible to users according to the business rules.

6. The method of claim 5 wherein invoking further comprises providing processing parameters, the processing parameters employed by the geospatial operations for processing the geospatial data sets.

7. The method of claim 1 wherein the business rules are further indicative of a conditional sequence of execution based on the users invoking the plugin and the geospatial data sets requested by the invocation.

8. The method of claim 7 wherein the plugin definition includes execution logic, the execution logic indicative of a sequence of geospatial operations performable on at least one geospatial data set.

9. The method of claim 1 further comprising defining the set of instructions in a plugin definition, the plugin definition having instruction segments, the instruction segments including specifications of least one of geospatial operations, geospatial data sets, users, parameters and execution logic.

10. The method of claim 9 wherein the execution logic further comprises an indication and sequence of at least one geospatial operation to perform, each of the geospatial operations including at least one transformation on at least one of the geospatial data sets.

11. The method of claim 10 wherein the plugin definition includes qualifiers for each of the instruction segments, the qualifiers indicative of conditional performance effecting the sequence and security of operations executable by the plugin definition.

12. The method of claim 11 further comprising:
selecting geospatial data sets for inclusion in transformations specified by the operations instruction segment in the plugin; and
validating that the selected geospatial data sets are compatible with the transformations.

13. The method of claim 2 further comprising defining the plugin definition via a graphical user interface operable to interactively query a user for instruction segments, the instruction segments including:
business rules, the business rules defining applicable geospatial operations, users and data sets;
execution logic indicative of an order for performing the defined operations on the data sets defined in the business rules;
plugin parameters operable for interactive specification; and
security constraints indicative of restrictions on performance of the execution logic.

14. The method of claim 13 further comprising interactively specifying the plugin parameters during execution of the plugin, the plugin parameters being independent of the execution logic defining the sequence of operations performed.

15. A geospatial data provisioning framework comprising:
a user interface operable to define a set of instructions for processing at least one geospatial data set;
a custom plugin generator operable to generate a plugin definition from the set of instructions, the plugin definition defining at least one business rule indicative of geospatial data sets applicable to the set of instructions; and
an application repository operable to register the plugin definition and the defined business rules for access via an interactive geospatial data provisioning engine.

16. The framework of claim 15 wherein the plugin definition further includes an indication of a set of applicable operations, a set of applicable data sets, and a set of applicable users.

17. The framework of claim 16 wherein the business rules are indicative of at least one of:
geospatial data sets upon which the plugin definition is operable;
geospatial operations applicable to the geospatial data sets; and
users permitted to employ particular geospatial operations.

18. The framework of claim 17 wherein the user interface is further operable to:
define the set of instructions in a self describing document; and
transform the self describing document into the plugin definition.

19. The framework of claim 18 further comprising a graphical user interface operable to:
select the registered plugin from a set of registered plugins; and
invoke the registered plugin according to predetermined semantics, the registered plugin accessible to users according to the business rules.

20. The framework of claim 19 wherein the user interface is further operable to provide processing parameters, the processing parameters employed by the geospatial operations for processing the geospatial data sets.

21. The framework of claim 15 wherein the business rules are further indicative of a conditional sequence of execution based on the users invoking the plugin and the geospatial data sets requested by the invocation.

22. The framework of claim 21 wherein the plugin definition includes execution logic, the execution logic indicative of a sequence of geospatial operations performable on at least one geospatial data set.

23. The framework of claim 15 wherein the user interface is further operable to define the set of instructions in a plugin definition, the plugin definition having instruction segments, the instruction segments including specifications of least one of geospatial operations, geospatial data sets, users, parameters and execution logic.

24. The framework of claim 23 wherein the plugin definition includes qualifiers for each of the instruction segments, the qualifiers indicative of conditional performance effecting the sequence and security of operations executable by the plugin definition.

25. The framework of claim 16 wherein the user interface is a graphical user interface wizard operable to interactively query a user for instruction segments, the instruction segments including:
business rules, the business rules defining applicable geospatial operations, users and data sets;
execution logic indicative of an order for performing the operations on the data sets defined in the business rules;
plugin parameters operable for interactive specification; and
security constraints indicative of restrictions on performance of the execution logic.

26. A computer program product having a computer readable medium operable to store computer program logic embodied in computer program code encoded thereon for provisioning geospatial data comprising:
computer program code for defining a set of instructions as a plugin definition for processing at least one geospatial data set; defining including defining the plugin definition via a graphical user interface operable to interactively query a user for instruction segments, the instruction segments including:
business rules, the business rules defining applicable geospatial operations, users and data sets;
execution logic indicative of an order for performing the operations on the data sets defined in the business rules;
plugin parameters operable for interactive specification; and
security constraints indicative of restrictions on performance of the execution logic;
computer program code for registering the defined set of instructions and the defined business rules for access via an interactive geospatial data provisioning engine;
computer program code for selecting the registered plugin from a set of registered plugins; and
computer program code for invoking the registered plugin according to predetermined semantics, the registered plugin accessible to users according to the business rules.

27. A computing device for provisioning geospatial data comprising:
means for defining a set of instructions for processing at least one geospatial data set;
means for defining at least one business rule indicative of geospatial data sets applicable to the set of instructions, the plugin definition further including execution logic, the execution logic indicative of a sequence of geospatial operations performable on at least one geospatial data set;
means for registering the defined set of instructions and the defined business rules for access via an interactive geospatial data provisioning, the business rules indicative of at least one of:
geospatial data sets upon which the plugin definition is operable;
geospatial operations applicable to the geospatial data sets; and
users permitted to employ particular geospatial operations; and
means for invoking the registered plugin according to predetermined semantics, the registered plugin accessible to users according to the business rules, the business rules further indicative of a conditional sequence of execution based on the users invoking the plugin and the geospatial data sets requested by the invocation.
